(19) United States
(12) Patent Application Publication
(10) Pub. No.: US 2020/0316994 A1
(43) Pub. Date: Oct. 8, 2020

(54) BLENDED LAYER FOR IMPROVED ADHESION IN TIRES

(71) Applicant: Bridgestone Americas Tire Operations, LLC, Nashville, TN (US)

(72) Inventors: Thaddeus T. Thompson, Massillon, OH (US); Anthony M. Unger, New Albany, OH (US)

(21) Appl. No.: 16/301,399

(22) PCT Filed: Apr. 11, 2017
(86) PCT No.: PCT/US2017/026909

§ 371 Date: Nov. 13, 2018

Related U.S. Application Data
(60) Provisional application No. 62/340,715, filed on May 24, 2016.

(51) Int. Cl. B60C 1/00; B60C 11/00; B60C 15/05

(52) U.S. Cl. CPC B60C 1/0016; B60C 2200/14; B60C 15/05; B60C 11/005

(57) ABSTRACT

Off road tires having a blended layer arranged in the crown portion are described for improving adhesion between the tread and underlying or adjacent tire components. Increased adhesion between tire components can reduce the frequency of separation and increase the service life of the tire. The blended layer contains a portion of the same material composition of a tire component that contacts the layer to ensure the blended layer has ingredients common with the adjacent component. As arranged between two tire components or layers, the blended layer can have a first portion and a second portion corresponding to compositions of the layers in contact with the blended layer. The incorporation of compositions in contact with the blended layer allows the blended layer to simulate entanglement between materials and increases the bonding strength between the layer and other components in the tire.

### TECHNICAL FIELD

The present disclosure relates to pneumatic bias tires having a blended transition layer arranged between a tread cap and a tread base layer, and more particularly, pneumatic bias tires having the blended layer for use in off-the-road (OTR) applications.

### BACKGROUND

Larger sized tires designed for off-the-road applications (e.g., use in mines, agriculture, construction sites, etc.) with large-sized vehicles contain a significant amount of rubber material in the tread cap as compared to passenger tires. The OTR tires are often subject to severe service requirements for extended periods of time. For example, the OTR tires can be required to withstand heavy loads and travel over rough terrain such as debris, packed soil conditions, rocks, and broken concrete. Over time the tires deform and contract repeatedly and the increased amount of rubber material generates high amounts of heat during operation. As the tires gain more time in the severe service conditions, the repeated stresses on the tire and the high heat generated in the tires can lead to compromised tire performance, including separation of the rubber material forming the tread portion from the belt layer, which decreases the service life of the tire.

Methods to address heat build up in the tread portion have included applying a base layer over the belt area to form a lower operating temperature portion. A base layer is incorporated into the tire as a new material having its own composition and different than the tread portion and the rubber skim coating the belt layer. The interface areas between the base layer and other materials directly in contact with the base layer can form a weak point where cracks could form and propagate through the tire. For instance, the adhesion between the base layer and tread portion or belt layer can decrease over the service life of the tire and thereby lead to separation of the layers. A decrease in the service life of an OTR tire reduces the return on investment in the tires, which can result in increased maintenance and down time for a large vehicle.

It is an objective of the present disclosure to overcome one or more difficulties related to the prior art. A tire having improved adhesion between the tread portion and the base layer underlying the tread portion can have a longer service life and increase return on investment for an OTR tire. It has been found that use of a blended layer arranged between a tread cap or portion and a tread base layer can improve adhesion, which leads to a longer service life for an OTR tire.

### SUMMARY

In a first aspect, there is a pneumatic bias tire that includes a carcass, a sub-tread base layer disposed radially outward from the carcass, the sub-tread base layer having a sub-tread base layer composition, a tread disposed radially outward from the sub-tread base layer, the tread having a tread composition and a blended layer positioned between the tread and the sub-tread base layer, the blended layer having a first portion and a second portion, the first portion having a first portion composition the same as the tread composition and the second portion having a second portion composition the same as the sub-tread base layer composition.

In an example of aspect 1, the tire is an off-the-road tire.

In another example of aspect 1, the tire has an outside diameter of at least about 45 inches.

In another example of aspect 1, the first portion is at least 20 weight percent of the total weight of the blended layer.

In another example of aspect 1, the first portion is at least 40 weight percent of the total weight of the blended layer.

In another example of aspect 1, the second portion is at least 20 weight percent of the total weight of the blended layer.

In another example of aspect 1, the second portion is at least 40 weight percent of the total weight of the blended layer.

In another example of aspect 1, the first portion and the second portion are together at least 60 weight percent of the total weight of the blended layer.

In another example of aspect 1, the blended layer has a ratio of the first portion to the second portion in the range of 0.5:1.5 to 1.5:0.5.

In another example of aspect 1, the sub-tread base layer is not in contact with the tread.

In another example of aspect 1, a portion of the sub-tread base layer is in contact with the tread.

In another example of aspect 1, the blended layer extends axially beyond an axial edge of the sub-tread base layer.

In another example of aspect 1, the blended layer is in contact with the tread and the sub-tread base layer.

In another example of aspect 1, the blended layer has a thickness greater than the sub-tread base layer.

In another example of aspect 1, the blended layer has an average thickness less than the sub-tread base layer.

In another example of aspect 1, the sub-tread base layer and the blended layer are free of a belt or ply.

In another example of aspect 1, the tire comprises two sub-tread layers, each sub-tread layer having a blended layer positioned between it and the tread.

In another example of aspect 1, the blended layer has a rubber component and a reinforcing filler, wherein the amount of the reinforcing filler in the blended layer is greater than an amount of reinforcing filler in the sub-tread base layer and less than an amount of reinforcing filler in the tread.

In another example of aspect 1, the reinforcing filler of the blended layer has a blend of at least two fillers, and the at least two fillers are different from one another.

The first aspect may be provided alone or in combination with any one or more of the examples of the first aspect discussed above.

In a second aspect, there is an off-the-road pneumatic tire that includes a carcass, a sub-tread base layer disposed radially outward from the carcass, the sub-tread base layer having a sub-tread base layer composition, a tread disposed radially outward form the sub-tread base layer, the tread having a tread composition, and a blended layer positioned between and in contact with the tread and the sub-tread base layer, the blended layer includes a blend of the sub-tread base layer composition and the tread composition.

In an example of aspect 2, blended layer contains at least 20 weight percent of the sub-tread base layer composition based on the total weight of the blended layer.

In another example of aspect 2, the blended layer contains at least 20 weight percent of the tread composition based on the total weight of the blended layer.

The second aspect may be provided alone or in combination with any one or more of the examples of the second aspect discussed above, or with any one or more of the examples of the first aspect.

The accompanying drawings are included to provide a further understanding of principles of the invention, and are incorporated in and constitute a part of this specification. The drawings illustrate one or more embodiment(s), and together with the description serve to explain, by way of example, principles and operation of the invention. It is to be understood that various features disclosed in this specification and in the drawings can be used in any and all combinations. By way of non-limiting example the various features may be combined with one another as set forth in the specification as aspects.

### BRIEF DESCRIPTION OF THE DRAWINGS

The above description and other features, aspects and advantages are better understood when the following detailed description is read with reference to the accompanying drawings, in which:

FIG. 1 is a cross-sectional view of an off-the-road tire taken along the tread width direction.

FIG. 2 shows a graph of measured adhesion between various sample materials and a blended layer made from the sample materials.

FIG. 3 shows a graph of measured adhesion between various sample materials and a blended layer made from the sample materials.

### DETAILED DESCRIPTION

The terminology as set forth herein is for description of the embodiments only and should not be construed as limiting the invention as a whole.

Herein, when a range such as 5-25 (or 5 to 25) is given, this means preferably at least or more than 5 and, separately and independently, preferably not more than or less than 25. In an example, such a range defines independently at least 5, and separately and independently, not more than 25.

The present disclosure relates to the use and incorporation of a blended material into an off-the-road tire. Off-the-road tires are designed for harsh conditions and are large relative to passenger tires, for example, the OTR tires can have an overall diameter of at least 35, 40, 45, 50, 55, 60, 80, 100, 120, 140 or 160 inches. The OTR tires can be bias type or radial type depending on the desired service and performance characteristics. The increased size and cost of OTR tires, and the harsh service demands for the tires, make maximizing the length of tire service life advantageous. Compromised tire performance often includes separation of component materials within the tire and thus improved adhesion of materials can reduce the frequency of tire separations and problems. The blended material of the present disclosure can enhance the adhesion with a material or between two materials in the tire.

By containing at least a portion of the same material composition of a tire component that contacts the blended material, the blended material is ensured to have common components or ingredients that are present in the tire component and the blended material can have improved adhesion with that tire component. For example, a blended layer can include the same elastomer (e.g., natural rubber) as present in a tire component material in contact with the blended layer. The blended layer can simulate entanglement between materials (e.g., elastomers) in the blended layer and a tire component material, which can increase bonding strength after curing the green tire materials (e.g., in a tire). Multiple tire components can be bonded to the blended material. For instance, the blended material can be in contact with more than one tire component, and in such cases, the blended material can include more than one portion that correspond to the multiple tire components that contact the blended material. A blended material including compositions of two tire components can be positioned in a tire to dissipate forces encountered by a tire over a broader area as compared to forces that were formerly concentrated at the interface between the two tire components. The ability of the blended material to dissipate forces over a larger area reduces the likelihood of the two tire components from separating from one another.

In one or more embodiments, the blended layer has a composition that contains a portion having the same composition as a tire component that it contacts as arranged in the tire. For example, the blended layer can be in contact with the tread, and a portion of the blended layer composition can be the same as the tread composition. In another embodiment, the blended layer can be positioned between or in contact with two separate tire components. To enhance adhesion between the two tire components, the composition of the blended layer can include two portions, each portion having a composition the same as one of the two tire component compositions. In yet another embodiment, the blended layer can be in contact with more than two tire components. The blended layer can have more than two portions each having corresponding tire component compositions of the more than two tire components in contact with the blended layer.

The blended material can be incorporated into the crown portion of the tire, for example, as a material under the tread or ground-contacting surface of the tire. The blended material can be present in the tire in any suitable shape or form, for instance, as one or more layers. Tire construction of the present disclosure can include a circumferential tread portion and a sub-tread portion (e.g., a sub-tread base layer). The blended material can be positioned in the tire near or adjacent to the tread, the sub-tread or a combination thereof. In one or embodiments, the blended material is arranged between the tread and the sub-tread portions of the tire.

Positioned between the tread and the sub-tread portion or portions of the tire, the blended material can, in one example, entirely separate the tread from the sub-tread portions from contacting one another. For example, the sub-tread portion can be one or more circumferential layers underlying the tread and each having axial edges. For example, the sub-tread portion can be a single layer overlying a belt assembly or two or more circumferential strips not in contact with one another and overlying a belt assembly. The blended material can overlie the entire surface of the sub-tread portion facing the tread (e.g., be in contact with the sub-tread portion) and further extend axially beyond the axial edges of the sub-tread portion. In another embodiment, the blended material can cover a portion of the sub-tread portion, for example, the blended material can cover at least 30, 40, 50, 60, 70, 80, 85, 90 or 95 percent of the sub-tread portion surface facing the tread of the tire. In the case the blended material does not cover the entire sub-tread portion surface facing the tread, a portion of the sub-tread portion can be in contact with the tread of the tire.

The blended material is preferably a layer or layers positioned between the tread and the sub-tread base layer or layers. The blended layers can have any suitable thickness, for example, its thickness can be characterized relative to the thickness of adjacent tire components. In one embodiment, the blended layer can have a thickness equal to or greater than an underlying sub-tread base layer. In another embodiment, the blended layer can have a thickness 1.25, 1.5, 1.75, 2, 2.25 or 2.5 times greater than the tire component material underlying and in contact with the blended layer. In yet another embodiment, the blended layer can have a thickness equal to or less than an underlying sub-tread base layer, for example, less than 1.25, 1.5, 1.75, 2, 2.25 or 2.5 times less than the tire component material underlying and in contact with the blended layer. Alternatively, the blended layer can have a thickness less than the thickness of the tire component material underlying and in contact with the blended layer. In another embodiment, the blended layer underlies a tire component (e.g., tread) and the blended layer can have a thickness equal to or less than an overlying tire component layer. For example, the blended layer can have a thickness 1.5, 2, 2.5, 3, 3.5, 4, 4.5 or 5 times less than the tire component material overlying and in contact with the blended layer. Thickness of a tire component in contact with the blended material is measured at its thickest radial point.

As arranged between the tread and sub-tread base layer of a pneumatic tire, for example a pneumatic bias off-the-road tire, the blended layer can have a composition that includes a portion with the same composition as the tread composition or the sub-tread base layer composition. In another embodiment, the blended layer can have a composition that includes two portions, a first portion and a second portion. The first portion can have the same composition as the tread composition and the second portion can have the same composition as the sub-tread base layer composition. The first portion of the blended layer composition can be present in an amount range of 20 to 80 or 40 to 60 weight percent of the total weight of the blended layer, or at least 20, 30, 40, 50 or 60 weight percent of the total weight of the blended layer. The second portion of the blended layer composition can be present in an amount range of 20 to 80 or 40 to 60 weight percent of the total weight of the blended layer, or at least 20, 30, 40, 50 or 60 weight percent of the total weight of the blended layer. The remaining portion or weight of the blended layer composition other than the first and second portions can be a combination of one or more suitable ingredients as known in the art, for example, elastomer, filler, curing agents, etc.

In another embodiment, the first and second portions together can be at least 60, 70, 80, 85, 90, 95 or 100 weight percent of the total weight of the blended layer. In yet another embodiment, the first and second portions can be present in the blended layer in a ratio of the first portion to the second portion in the range of 0.5:1.5 to 1.5:0.5, 0.75:1.25 to 1.25:0.75 or in a 1:1 ratio. In one example, the blended layer composition can be 50 weight percent of the first portion and 50 weight percent of the second portion.

The tire components of the present disclosure in contact with the blended layer, for example the tread and sub-tread base material, can include any suitable polymer for tread rubber, e.g., natural or synthetic rubbery polymer. The tread and sub-tread base materials can both be generally referred to as being made of tread rubber. Examples of rubbery polymers that may be used in the compositions described herein include, but are not limited to, natural rubber, synthetic polyisoprene rubber, styrene-butadiene rubber (SBR), styrene-isoprene rubber, styrene-isoprene-butadiene rubber, butadiene-isoprene-styrene terpolymer, butadiene-isoprene rubber, polybutadiene, butyl rubber, neoprene, acrylonitrile-butadiene rubber (NBR), silicone rubber, the fluoroelastomers, ethylene acrylic rubber, ethylene-propylene rubber, ethylene-propylene terpolymer (EPDM), ethylene vinyl acetate copolymer, epichlorohydrin rubber, chlorinated polyethylene-propylene rubbers, chlorosulfonated polyethylene rubber, hydrogenated nitrile rubber, terafluoroethylene-propylene rubber and combinations thereof. In one embodiment, the tread rubber compositions can include only natural rubber. A mixture of two or more rubbery polymers may be used. In one embodiment, the tread rubber composition may comprise a mixture of natural rubber and synthetic rubber (e.g., styrene-butadiene rubber).

The tread rubber compositions preferably also contain a reinforcing filler. The filler may be selected from the group consisting of carbon black, silica, and mixtures thereof. The total amount of filler may be from about 1 to about 200 phr, alternatively from about 5 to about 100 phr, from about 10 phr to about 30 phr, from about 30 to about 80 phr, or from about 40 to about 70 phr.

Carbon black, when present, may be used in an amount of about 1 to about 200 phr, in an amount of about 5 to about 100 phr, or alternatively in an amount of about 30 to about 80 phr or about 35, 40, 45 or 50 phr. Suitable carbon blacks include commonly available, commercially-produced carbon blacks, but those having a surface area of at least 20 m²/g, or preferably, at least 35 m²/g and up are preferred. Among useful carbon blacks are furnace blacks, channel blacks, and lamp blacks. A mixture of two or more carbon blacks can be used. Exemplary carbon blacks include, but are not limited to, N-110, N-220, N-339, N-330, N-352, N-550, N-660, as designated by ASTM D-1765-82a.

Examples of reinforcing silica fillers which can be used include wet silica (hydrated silicic acid), dry silica (anhydrous silicic acid), calcium silicate, and the like. Among these, precipitated amorphous wet-process, hydrated silicas are preferred. Silica can be employed in an amount of about 1 to about 100 phr, in an amount of about 5 to about 80 phr, or alternatively in an amount of about 10 to about 50 phr or about 12, 14, 16, 18 or 20 phr. The useful upper range is limited by the high viscosity imparted by fillers of this type. Some of the commercially available silicas which can be used include, but are not limited to, HiSil 190, HiSil 210, HiSil 215, HiSil 233, HiSil 243, and the like, produced by PPG Industries (Pittsburgh, Pa.). A number of useful commercial grades of different silicas are also available from DeGussa Corporation (e.g., VN2, VN3), Rhone Poulenc (e.g., Zeosil 1165 MPO), and J. M. Huber Corporation.

The surface of the carbon black and/or silica may optionally be treated or modified to improve the affinity to particular types of polymers. Such surface treatments and modifications are well known to those skilled in the art.

Additional fillers may also be utilized, including but not limited to, mineral fillers, such as clay, talc, aluminum hydrate, aluminum hydroxide and mica. The foregoing additional fillers are optional and can be utilized in varying amounts from about 0.5 phr to about 40 phr.

The tread rubber composition may comprise zinc oxide in an amount of about 0.1 to about 10 phr, from about 1 to about 7 phr, from about 2 to about 5 phr or about 3 or 4 phr. Other ingredients that may be added to the tread rubber composition include, but are not limited to, oils, waxes, scorch inhibiting agents, tackifying resins, rosins, reinforcing resins, fatty acids such as stearic acid, and peptizers. These ingredients are known in the art, and may be added in appropriate amounts based on the desired physical and mechanical properties of the rubber composition. For example, one or more of these other ingredients may be in an amount of about 0.1 to about 5 phr, from about 0.2 to about 4 phr, from about 0.3 to about 3 phr or about 0.4, 0.5, 0.6, 0.7, 0.8, 0.9, 1, 1.5, 2 or 2.5 phr.

Vulcanizing agents and vulcanization accelerators may also be added to the tread rubber composition. Suitable vulcanizing agents and vulcanization accelerators are known in the art, and may be added in appropriate amounts based on the desired physical, mechanical, and cure rate properties of the rubber composition. Examples of vulcanizing agents include sulfur and sulfur donating compounds. The amount of the vulcanizing agent used in the rubber composition may, in certain embodiments, be from about 0.1 to about 10 phr, from about 0.2 to about 5 phr, from about 0.3 to about 4 phr or about 0.4, 0.5, 0.6, 0.7, 0.8, 0.9, 1, 1.5, 2, 2.5, 3 or 3.5 phr.

When utilized, the particular vulcanization accelerator is not particularly limited. Numerous accelerators are known in the art and include, but are not limited to, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), 2-(morpholinothio)benzothiazole (MBS), N-tert-butyl-2-benzothiazole sulfonamide (TBBS), N-cyclohexyl-2-benzothiazole sulfonamide (CBS), and mixtures thereof. The amount of vulcanization accelerator(s) used in the rubber composition may be from about 0.1 to about 10 phr, from about 0.2 to about 5 phr, from about 0.3 to about 4 phr or about 0.4, 0.5, 0.6, 0.7, 0.8, 0.9, 1, 1.5, 2, 2.5, 3 or 3.5 phr.

The tread, blended material and sub-tread base rubber compositions may be formed by mixing the ingredients together by methods known in the art, such as, for example, by kneading the ingredients together in a Banbury mixer. For example, the tread rubber composition may be mixed in at least two mixing stages. The first stage may be a mixing stage where no vulcanizing agents or vulcanization accelerators are added, commonly referred to by those skilled in the art as a non-productive mixing stage. In certain embodiments, more than one non-productive mixing stage may be used. The final stage may be a mixing stage where the vulcanizing agents and vulcanization accelerators are added, commonly referred to by those skilled in the art as a productive mixing stage. The non-productive mixing stage(s) may be conducted at a temperature of about 130° C. to about 200° C. The productive mixing stage may be conducted at a temperature below the vulcanization temperature in order to avoid unwanted pre-cure of the rubber composition. Therefore, the temperature of the productive mixing stage should not exceed about 120° C. and is typically about 40° C. to about 120° C., or about 60° C. to about 110° C. and, especially, about 75° C. to about 100° C.

As described herein, the blended material composition contains one or more portions having the composition of one or more tire components and thereby the blended material can contain rubber tread and sub-tread composition ingredients in the amounts described in the present disclosure. For example, the tread and sub-tread base material can include a reinforcing filler or combination of fillers like carbon black and silica. A blended layer in contact with the tread and sub-tread base material can likewise include the an elastomer component and reinforcing filler or combination of elastomers or fillers as present in the tread in sub-tread base material. In one embodiment, the blended layer composition can contain portions having the composition ingredients of the tread and sub-tread materials. Depending on the portion amounts corresponding to the tire component compositions in the blended layer, the blended layer can have specific ingredient amounts that are more than or less than an adjacent tire component's ingredient amounts. For instance, the blended layer composition can include an amount of reinforcing filler or a combination of fillers (e.g., two different fillers) that is greater than that present in an adjacent tire component (e.g., a sub-tread) base layer and less than in a separate tire component (e.g., tread).

In one or more embodiments, as used herein, the term “same composition” refers to a composition having at least all of the components of another composition. For example, if the tread composition includes natural rubber and carbon black, the blended layer composition, with a first portion having first portion composition the same as the tread composition, would include natural rubber and carbon black. The term “same composition” can optionally refer to a composition having the identical component of another composition. For example, if the tread composition includes a particular grade of carbon black (e.g., N220), the blended layer composition, with a first portion having first portion composition the same as the tread composition, would include carbon black, which can optionally be carbon black N220 or another grade of carbon black. As used in the same composition term, a component refers to a particular ingredient (e.g., carbon black) and not to a class of ingredients (e.g., filler). For example, if the tread composition includes carbon black, the blended layer composition, with a first portion having first portion composition the same as the tread composition, would at least include carbon black, rather than only a non-carbon black component, such as another filler (e.g., silica).

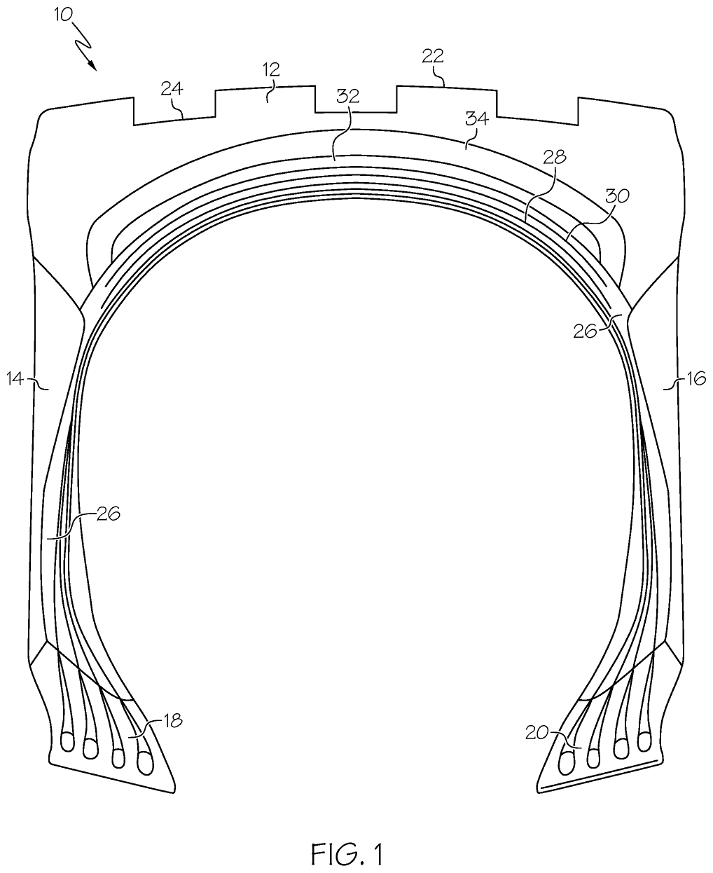

Examples of the use and properties of the blended material of the present disclosure are shown in the Figures. In FIG. 1 an off-the-road pneumatic tire 10 includes a circumferential tread or tread portion 12, first and second sidewalls or sidewall portions 14 and 16, and first and second beads or bead portions 18 and 20. The tread portion 12 includes a plurality of lugs 22 extending upward from a tread floor 24.

The off-the-road tires utilizing the present design are also relatively large tires which have outside diameters in a range of from about 35 to about 160 inches. The design is especially useful on the very large tires having outside diameters of greater than about 45 inches.

A carcass 26 includes a plurality of carcass plies, sometimes also referred to as body plies. In the embodiment illustrated, the carcass 26 includes four carcass plies. In general, the carcass 26 may include from two to six carcass plies. Each of the carcass plies extends circumferentially about the tire. The carcass plies each can include an axially inner portion and axially outer portions that extend around the bead portions and extend upwardly toward the tread portion and terminate at turn-up ends. The carcass plies may be nylon cord reinforced carcass plies.

A plurality of circumferentially extending belts 28, 30 are disposed between the carcass 26 and the sub-tread base layer 32. Preferably, the sub-tread base layer 32 overlies and does not encase the one or more belts of the tire 10. In one embodiment the plurality of belts can include from two to eight belts, or four or six belts. The belts may be Nylon, aramid or metal cord reinforced belts. The belts may be biased in alternating layers, for instance, in a range of from about 69° to 77° to the rotational axis of the tire.

In another embodiment the tire may have two steel reinforced belts and from two to six fabric reinforced radial carcass plies. In still another embodiment the tire may have two steel reinforced belts and one steel reinforced radial carcass ply.

The belts have axial end edges, which can be staggered to create a tapered edge on the package of belts. A belt edge insert (not shown) can extend under the edge of the belts, and also extends downward into the sidewall portion. The belt edge insert can serve to hold the axially outer portions of the belts in a substantially horizontal orientation so that they do not follow the downward curve of the carcass.

A sub-tread base layer 32 is located between the circumferential tread portion 12 and the belts 28, 30. In the embodiment of FIG. 1 it is seen that the sub-tread base layer 32 extends to an axial edge not beyond the axial edges of the belts. Alternatively, the axial edge of layer 32 can extend well beyond the belt edges. As shown, the sub-tread base layer 32 is single layer in contact with the blended layer 34 and entirely separate from contact with the tread 12. The sub-tread base layer 32 may be formed by calendaring a uniform thickness sheet of sub-tread compound material around the tire carcass and belts on a rotating tire building machine. Alternatively, not shown, the tire can have two circumferential sub-tread layers located between the tread 12 and belts 28, 30. The two circumferential sub-tread layers are preferably not in contact with one another and positioned near the shoulder area of the crown portion or axial edge of the belts.

The sub-tread base layer 32 preferably has a radial thickness in the range of from about 0.1 inch to about 0.5 inch, more preferably in the range of from about 0.15 inch to about 0.4 inch, and most preferably approximately 0.2 inch. The thickness of the sub-tread base layer 32 can also be described as being preferably at least about 0.1 inch, and more preferably at least about 0.15 inch.

A blended layer 34 is positioned between the circumferential tread portion 12 and the sub-tread base layer 32. FIG. 1 shows the blended layer 34 in contact with tread 12 and sub-tread base layer 32. The blended layer 34 entirely covers the outermost surface and axial edges of the sub-tread base layer 32. In an alternative arrangement, a tire having two or more circumferential sub-tread layers can have two or more blended layers positioned between the tread 12 and the sub-tread layers. For example, the two or more blended layers can entirely cover the outermost surface and axial edges of the sub-tread layers such that the tread portion is not in contact with the sub-tread layers.

The blended layer 34 preferably has a radial thickness in the range of from about 0.2 inch to about 1 inch, more preferably in the range of from about 0.25 inch to about 0.75 inch, and most preferably about 0.3 to about 0.6 inch. The thickness of the blended layer 34 can also be described as being preferably at least about 0.1 inch, and more preferably at least about 0.2 inch. The blended layer 34 may be formed by calendaring a uniform thickness sheet of blended compound material around the tire carcass and/or base layer on a rotating tire building machine as known in the art.

The blended layer 34 is positioned in the tire 10 to enhance the bonding of it to both the sub-tread base layer 32 and the tread portion 12. The blended layer 34 can be made of a blend of material having the sub-tread composition and the tread composition and thus composition components of the tread and sub-tread portions are common to the blended layer. The tread 12 and sub-tread 32 layers can have compositional differences. For example, the sub-tread base layer 32 can be made of a material having a lower hysteresis as compared to the tread portion 12 material. The sub-tread base layer may be referred to as a low hysteresis layer as compared to the tread. The hysteresis of an elastomeric compound is a measure of the internal energy dissipation in the compound when subjected to deformation. For tires, the hysteresis of the tire rubber compound relates to the amount of heat that will be generated internally in the compound when it is subjected to stresses such as those encountered in a rolling tire. A parameter commonly used to quantify the hysteresis of elastomeric compounds is the “tan delta” value of the compound. The tan delta value is the ratio of the viscous response to the elastomeric response of the compound. To reduce the heat generated during operation, the sub-tread base layer preferably has a lower hysteresis as compared to the tread.

The hysteresis of the sub-tread base layer is dependent on both the rubber selected and the fillers added to the rubber. One factor which can contribute to a sub-tread base layer having a lower hysteresis than the circumferential tread portion is to use a substantially higher natural rubber content in the sub-tread than in the circumferential tread. The hysteresis of the rubber compound can also be affected by the various fillers added to the rubber. The use of lower proportions of fillers also generally corresponds to lower hysteresis values for the rubber compound.

By selecting a sub-tread compound having a higher natural rubber content than that of the circumferential tread portion 12, and preferably having a rubber content of substantially 100% natural rubber, and/or by selecting a sub-tread compound having a relatively lower proportion of fillers, the sub-tread base layer 32 will generate less heat internally than does the circumferential tread portion 12, thus exposing the belts to less heat. For example, a sub-tread base layer 32 having a lower proportion of fillers as compared to the tread 12 can result in a blended layer 34 having a greater amount of fillers than the base layer 32 but less than the tread 12. In another example, a sub-tread base layer 32 having a greater proportion of natural rubber as compared to the tread 12 can result in a blended layer 34 having greater natural rubber content than the tread 12 but less than the base layer 32.

The following examples illustrate specific and exemplary embodiments and/or features of the embodiments of the present disclosure. The examples are provided solely for the purposes of illustration and should not be construed as limitations of the present disclosure. Numerous variations over these specific examples are possible without departing from the spirit and scope of the presently disclosed embodiments. More specifically, the particular layer materials utilized in the examples should not be interpreted as limiting since other such ingredients consistent with the disclosure in the Detailed Description can utilized in substitution. That is, the particular ingredients in the compositions, as well as their respective amounts and relative amounts should be understood to apply to the more general content of the Detailed Description.

### Example 1

Adhesion Test

The adhesion of a blended material was tested and compared to adhesion of two different rubber compounds. Samples of three compositions were prepared. Samples A represent samples prepared from a tread material composition. Samples B represent samples from a sub-tread base material composition. Blend A/B represents samples made by mixing 50 weight percent of the tread material composition (Sample A) with 50 weight percent of the sub-tread material composition (Sample B) (i.e. a 1:1 ratio of Sample A to Sample B). Four test runs each having 5 adhered samples were evaluated. Each test run had the following adhered samples: (1) Sample A adhered to Sample A; (2) Sample A adhered to Blend A/B; (3) Sample A adhered to Sample B; (4) Blend A/B adhered to Sample B; and (5) Sample B adhered to Sample B.

The samples were bonded to one another in a mold in a green state (uncured) at set temperatures in the range of 65° C. to 85° C. and press pressures in the range of 1.1 to 2.2 tons. In the mold, two sample pieces were placed between two platens and then heated to a specified temperature and pressed at a set pressure for a pre-determined period of time to adhere the sample pieces together. The temperature of the platens and press pressure used in the test is less than needed to initiate curing.

Each of the rubber samples (i.e. Samples A, B and A/B) had a thickness of 3.175 mm, a length of 152.4 mm and a width of 25.4 mm. Mylar strips having a gauge of 0.005 mm and a width of 7.7 mm were placed along each edge between the samples before heating such that there was a contact area between the samples of 10 mm along the entire 152.4 mm length. After pre-heating the samples in a convection oven for a period of 30 minutes to bring the samples to a select uniform temperature, and the samples were placed in the mold and maintained at the select pre-heat uniform temperature and at a constant pressure for 10 minutes. After 10 minutes in the mold, the adhered samples were removed from the mold and allowed to cool under ambient conditions until the samples were at room temperature.

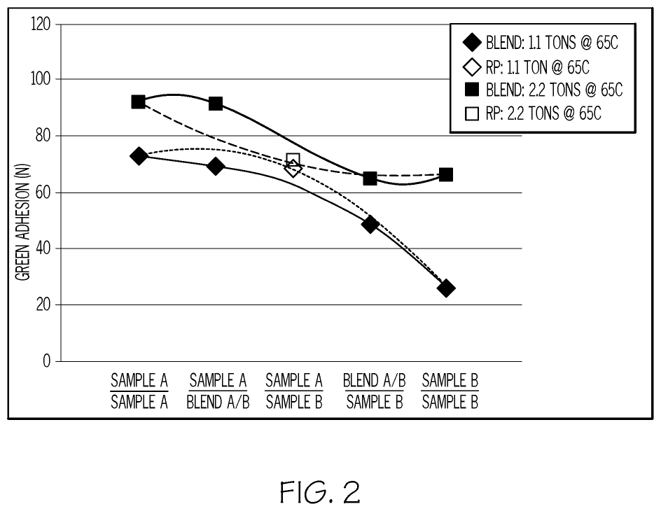

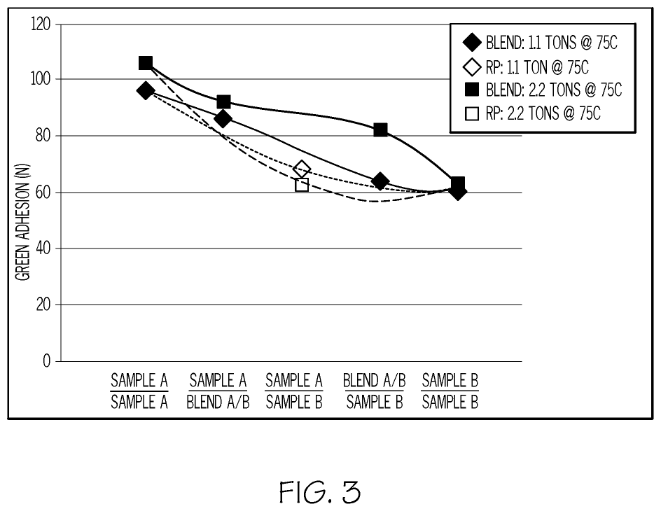

The cooled adhered samples were placed in a clamp and pulled apart at a rate of 50.8 mm per minute. The pulling was stopped after a length of 101.6 mm. The green adhesion (force need to separate the sample pieces) between the samples was measured and is plotted in FIGS. 2 and 3.

As can be seen in FIG. 2, the Blend A/B material adheres to Sample A as well as or about equal to the adhesion of Sample A to itself after heating at a temperature of 65° C. and at press pressures of 1.1 and 2.2 tons. Blend A/B exhibited an adhesion increase of about 25N or about 100% to Sample B (i.e. about 50N) as compared to Sample B adhered to itself (i.e. about 25N) after heating at a temperature of 65° C. at a press pressure of 1.1 tons. After heating to a temperature of 65° at a pressure of 2.2 tons, Blend A/B exhibited an adhesion as well as or about equal to the adhesion of Sample B to itself. As compared to the regular production (RP) arrangement of Sample A to Sample B (i.e. an adhesion of about 70N), Blend A/B to Sample A (i.e. about 90N) exhibited an adhesion increase of about 20 N or about 29% after heating at a temperature of 65° C. at a pressure of 2.2 tons. Thus, the use of Blend A/B can increase the adhesion of the tread material to the blended layer and base layer.

As can be seen in FIG. 3, Blend A/B exhibited an adhesion to Sample B greater than the Sample B material to itself, for example, Blend A/B measured an increase in adhesion to Sample B (i.e. about 82N) of about 20N or about 32% as compared to Sample B adhered to itself (i.e. about 62N) after heating at temperature of 75° C. under 2.2 tons of pressure. As compared to the regular production (RP) arrangement of Sample A to Sample B (i.e. about 70N), Blend A/B to Sample A (i.e. about 90N) exhibited an adhesion increase of about 20 N or about 29% after heating at a temperature of 75° C. at a pressure of 1.1 tons. After heating at a temperature of 75° C. at a pressure of 2.2 tons, Blend A/B to Sample A (about 92N) and Blend A/B to Sample B (about 82N) exhibit a greater adhesion than the regular production arrangement of Sample A to Sample B (about 62N). FIG. 3 represents a respective increase of about 30N (about 48%) and about 20N (about 32%) as measured between Blend A/B to Samples A and B and compared to regular production (Sample A to Sample B). Thus, the use of Blend A/B can increase the adhesion of the tread material to the blended layer and base layer.

Example 1 shows that measured green adhesion values tend to be greater for the blended layer to the tread or base layer materials than those for the tread to base layer interface. As the data from Example 1 indicates, increased pressure and temperature increases the blended layer adhesion to the tread and base layer materials and thus the blended layer can form a stronger and broader adhesion gradient between the tread and base layer in an off-the-road tire.

All references, including but not limited to patents, patent applications, and non-patent literature are hereby incorporated by reference herein in their entirety.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A pneumatic bias tire comprising:
a carcass;
a sub-tread base layer disposed radially outward from the carcass, the sub-tread base layer having a sub-tread base layer composition;
a tread disposed radially outward from the sub-tread base layer, the tread having a tread composition; and
a blended layer positioned between the tread and the sub-tread base layer, the blended layer comprising a first portion and a second portion, the first portion having a first portion composition the same as the tread composition and the second portion having a second portion composition the same as the sub-tread base layer composition.

2. The pneumatic bias tire of claim 1, the tire being an off-the-road tire.

3. The pneumatic bias tire of claim 1, the tire having an outside diameter of at least about 45 inches.

4. The pneumatic bias tire of claim 1, the first portion being at least 20 weight percent of the total weight of the blended layer.

5. The pneumatic bias tire of claim 1, the first portion being at least 40 weight percent of the total weight of the blended layer.

6. The pneumatic bias tire of claim 1, the second portion being at least 20 weight percent of the total weight of the blended layer.

7. The pneumatic bias tire of claim 1, the second portion being at least 40 weight percent of the total weight of the blended layer.

8. The pneumatic bias tire of claim 1, the first portion and the second portion being together at least 60 weight percent of the total weight of the blended layer.

9. The pneumatic bias tire of claim 1, the blended layer having a ratio of the first portion to the second portion in the range of 0.5:1.5 to 1.5:0.5.

10. The pneumatic bias tire of claim 1, the sub-tread base layer not being in contact with the tread.

11. The pneumatic bias tire of claim 1, the blended layer extends axially beyond an axial edge of the sub-tread base layer.

12. The pneumatic bias tire of claim 1, the blended layer being in contact with the tread and the sub-tread base layer.

13. The pneumatic bias tire of claim 1, the blended layer having an average thickness greater than the sub-tread base layer.

14. The pneumatic bias tire of claim 1, the blended layer having an average thickness less than the sub-tread layer.

15. The pneumatic bias tire of claim 1, the sub-tread base layer and the blended layer being free of a belt or ply.

16. The pneumatic bias tire of claim 1, the blended layer comprising a rubber component and a reinforcing filler, wherein the amount of the reinforcing filler in the blended layer is greater than an amount of reinforcing filler in the sub-tread base layer and less than an amount of reinforcing filler in the tread.

17. The pneumatic bias tire of claim 16, the reinforcing filler of the blended layer comprising a blend of at least two fillers, the two fillers being different from one another.

18. An off-the-road pneumatic tire comprising:
a carcass;
a sub-tread base layer disposed radially outward from the carcass, the sub-tread base layer having a sub-tread base layer composition;
a tread disposed radially outward form the sub-tread base layer, the tread having a tread composition; and
a blended layer positioned between and in contact with the tread and the sub-tread base layer, the blended layer comprising a blend of the sub-tread base layer composition and the tread composition.

19. The off-the-road pneumatic tire of claim 18, the blended layer comprising at least 20 weight percent of the tread composition based on the total weight of the blended layer.

20. The off-the-road pneumatic tire of claim 18, the blended layer comprising at least 20 weight percent of the sub-tread base layer composition based on the total weight of the blended layer.
